(19) United States
(12) Patent Application Publication
(10) Pub. No.: US 2009/0139381 A1
(43) Pub. Date: Jun. 4, 2009

(54) Screwdriver handle

(76) Inventor: Hui-Ni Lin, Changhua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,285

(22) Filed: Nov. 29, 2007

(51) Int. Cl. B25G 1/08; B25F 5/02

(52) U.S. Cl. 81/490

(57) ABSTRACT

A screwdriver handle includes a body having an angled hollow grip at the rear end and a chuck at the front end for the mounting of an adapter shaft to hold a screwdriver tip in axial alignment with the body, a rack insertable into the inside of the hollow grip and having two rows of vertically spaced C-shaped clamping plates for accommodating screwdriver tips and an extension rod holder groove for accommodating an extension rod, and a cap capped on the bottom end of the grip to close the grip and to hold down the rack firmly inside the grip

### BACKGROUND OF THE INVENTION

1. Field of the Invention

The present invention relates to a screwdriver and more particularly, to a screwdriver handle for screwdriver.

2. Description of the Related Art

The handle of a screwdriver may be made in the form of a solid cylinder convenient for the grasping of the hand. Alternatively, the handle of a screwdriver can be made in the form of a hollow cylinder that defines an accommodation space for accommodating screwdriver tips. Either the solid structure or the hollow design, the handle and the screwdriver tip extend in the same direction. When in operation, the user must employ much effort to the handle to rotate the screw.

### SUMMARY OF THE INVENTION

The present invention has been accomplished under the circumstances in view. According to one aspect of the present invention, the screwdriver handle has a body and a hollow grip arranged at right angles, a chuck provided at the front side of the body for the mounting of an adapter shaft to hold a screwdriver tip for rotating a screw, a rack insertable into an accommodation chamber defined in the hollow grip for accommodating screwdriver tips and an extension rod, and a cap capped on the bottom end of the hollow grip to close the accommodation chamber and to hold down the rack firmly in the hollow grip.

### BRIEF DESCRIPTION OF THE DRAWINGS

FIG. 1 is an exploded view of a screwdriver handle in accordance with the present invention.

FIG. 2 is a schematic sectional assembly view of the present invention.

### DETAILED DESCRIPTION OF THE PREFERRED EMBODIMENT

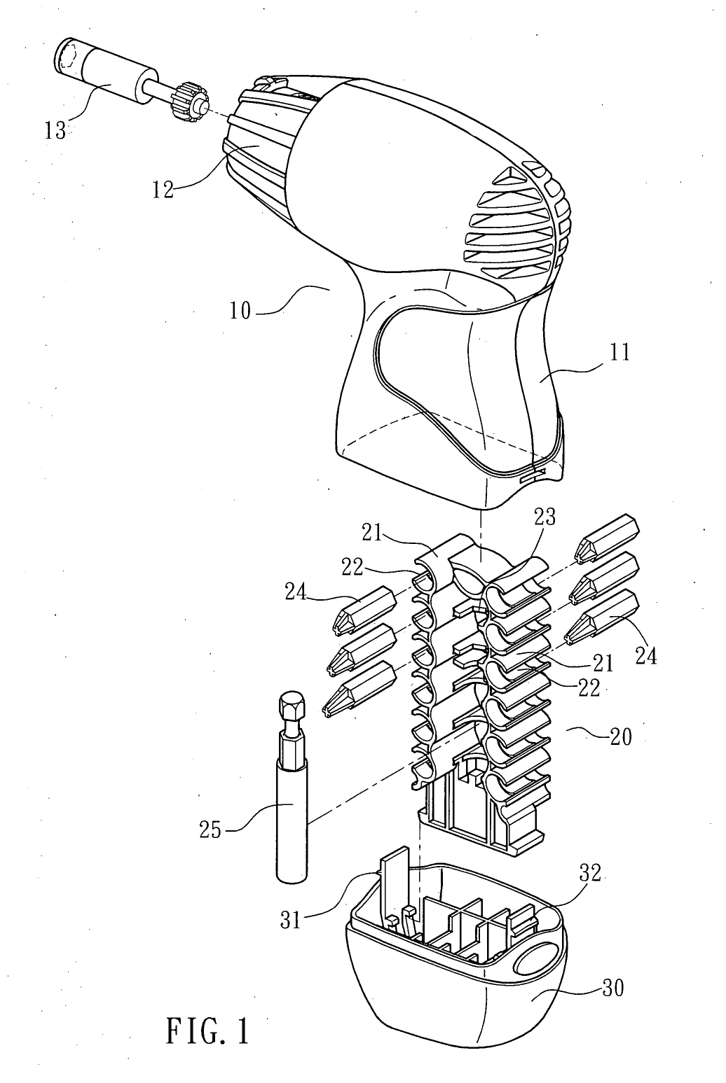

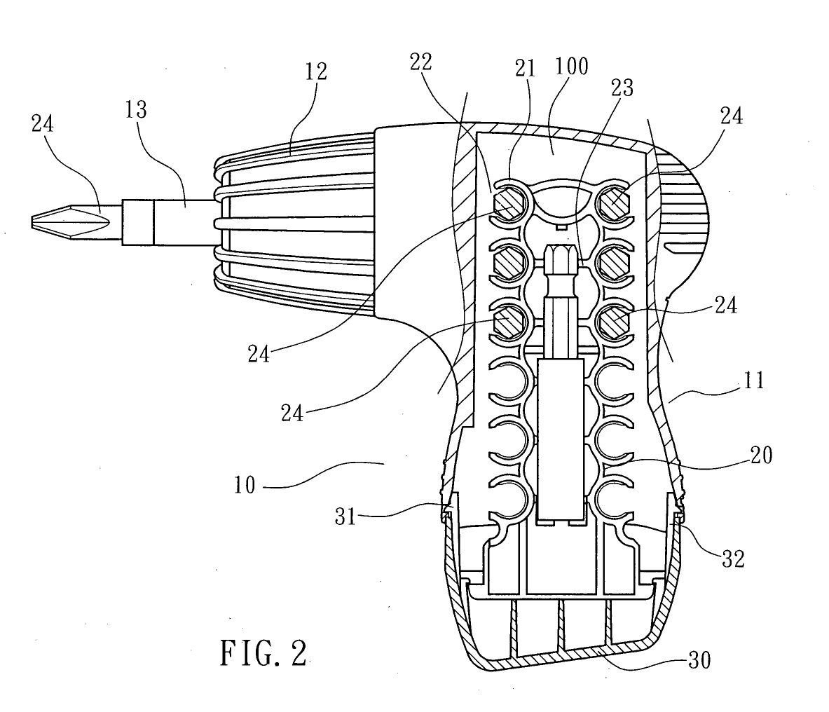

Referring to FIGS. 1 and 2, a screwdriver handle in accordance with the present invention is shown comprising a body 10, a hollow grip 11 connected to one end, namely, the rear end of the body 10 at right angles, a chuck 12 provided at the other end, namely, the front end of the body 10 for the mounting of an adapter shaft 13 to hold a screwdriver tip 24 in axial alignment with the body 10. The grip 11 defines an accommodation chamber 100. A cap 30 is capped on the bottom end of the grip 11 to close the accommodation chamber 100. The cap 30 has two hooks 31 and 32 that are fastened to the grip 11 to secure the cap 30 to the bottom end of the grip 11. A rack 20 is provided for holding screwdriver tips 24 and an extension rod 25. The rack 20 can be inserted into the accommodation chamber 100. After insertion of the rack 20 into the accommodation chamber 100, the cap 30 is capped on the bottom end of the grip 11 to close the accommodation chamber 100 and at the same time, to hold down the rack 20 firmly in place. The rack 20 comprises a plurality of C-shaped clamping plates 21 symmetrically disposed at two opposite sides at different elevations, and an extension rod holder groove 23 vertically disposed at one side between the two rows of C-shaped clamping plates 21 for holding an extension rod 25. The C-shaped clamping plates 21 each define a clamping space 22 for securing one screwdriver tip 24.

After removal of the cap 30 from the grip 11, the rack 20 can be taken out of the accommodation chamber 100 so that the user can attach screwdriver tips 24 and one extension rod 25 to the C-shaped clamping plates 21 and the extension rod holder groove 23 or remove the storage screwdriver tips 24 and extension rod 25 from the C-shaped clamping plates 21 and the extension rod holder groove 23.

Further, because the grip 11 extends from the rear end of the body 10 at right angles, the user can grasp the grip 11 with the hand and then drive the grip 11 to rotate the screw (not shown) via the adapter shaft 13 to hold the attached screwdriver tip 24 efficiently with less effort.

Although a particular embodiment of the invention has been described in detail for purposes of illustration, various modifications and enhancements may be made without departing from the spirit and scope of the invention. Accordingly, the invention is not to be limited except as by the appended claims.

1. A screwdriver handle comprising;
a body, and a hollow grip formed with the body to extend from a rear end of said body and thereby define a substantially L-shaped member,
said hollow grip defining an accommodation chamber,
a chuck provided at a front end of said body for the mounting thereto of an adapter shaft to hold a screwdriver tip in axial alignment with said body,
a rack insertable into said accommodation chamber, said rack comprising two rows of vertically spaced C-shaped clamping plates disposed at two opposite sides and an extension rod holder groove vertically disposed at one side between said two rows of C-shaped clamping plates, said C-shaped clamping plates each defining a clamping space for securing one screwdriver tip, and
a cap capped on a bottom end of said grip to close said accommodation chamber and to hold down said rack inside said accommodation chamber.

2. The screwdriver handle as recited in claim 1, wherein said body and said hollow grip are integrally formed to extend transversely one from the other.

3. The screwdriver handle as recited in claim 1, wherein said rack is releasably captured within said accommodation chamber of said hollow grip by said cap, said cap being detachable from said rack.
